(19) United States
(12) Patent Application Publication
(10) Pub. No.: US 2026/0303554 A1
(43) Pub. Date: Oct. 1, 2026

(54) UTILIZING MACHINE LEARNING TO EVALUATE CHAT BOT INTERACTIONS

(71) Applicant: Chime Financial, Inc., San Francisco, CA (US)

(72) Inventor: Dennis Yang, San Francisco, CA (US)

(21) Appl. No.: 19/090,993

(22) Filed: Mar. 26, 2025

(51) Int. Cl. H04L 51/063; G06N 20/00; H04L 51/02

(52) U.S. Cl. CPC H04L 51/063; G06N 20/00; H04L 51/02

(57) ABSTRACT

The disclosure describes embodiments of systems, methods, and non-transitory computer readable storage media that utilize machine learning to evaluate an electronic communication interaction between an artificial intelligence communication bot and a user. For example, the disclosed systems can utilize a configurable machine learning model that enables easy addition, deletion, or editing of evaluation prompts that guide the machine learning model in evaluating the electronic communication interaction from the AI communications bot. In particular, the disclosed systems can utilize the evaluation prompts with an electronic communication transcript from the AI communications bot to generate communication analysis objects that represent statistics and/or data on the behavior and/or operation of the AI communications bot. In addition, the disclosed systems can utilize the evaluation prompts with an electronic communication transcript from the AI communications bot to trigger digital actions determined from the electronic communication interaction.

### BRIEF DESCRIPTION OF THE DRAWINGS

The detailed description is described with reference to the accompanying drawings in which:

FIG. 1 illustrates a schematic diagram of an environment for implementing an inter-network facilitation system and an AI electronic communication system in accordance with one or more implementations.

FIG. 2 illustrates an overview of an AI electronic communication system utilizing machine learning to evaluate an electronic communication interaction between an artificial intelligence communication bot and a user in accordance with one or more implementations.

FIG. 3 illustrates an AI electronic communication system identifying electronic communication interactions in accordance with one or more implementations.

FIG. 4 illustrates an AI electronic communication system utilizing a machine learning model to evaluate a communication interaction in accordance with one or more implementations.

FIG. 5 illustrates an AI electronic communication system displaying one or more communication analysis objects in accordance with one or more implementations.

FIG. 6 illustrates an AI electronic communication system utilizing an electronic notification generated by an electronic communication evaluation machine learning model in accordance with one or more implementations.

FIG. 7 illustrates an AI electronic communication system enabling configuration of an electronic communication evaluation machine learning model in accordance with one or more implementations.

FIG. 8 illustrates a flowchart of a series of acts for utilizing machine learning to evaluate an electronic communication interaction between an artificial intelligence communication (chat) bot and a user of a user account in accordance with one or more implementations.

FIG. 9 illustrates a block diagram of an exemplary computing device in accordance with one or more implementations.

FIG. 10 illustrates an example environment for an inter-network facilitation system in accordance with one or more implementations.

### DETAILED DESCRIPTION

This disclosure describes one or more embodiments of systems, computer-implemented methods, and non-transitory computer readable media that provide benefits and solve one or more of the following mentioned or other problems by utilizing machine learning to evaluate an electronic communication interaction between an artificial intelligence communication (chat) bot and a user of a user account. Indeed, the disclosure describes one or more embodiments of an artificial intelligence (AI) electronic communication system that generates digital actions and/or electronic communication analysis objects by utilizing a machine learning model to analyze an electronic communication interaction between an AI communication (chat) bot and a user. For example, the AI electronic communication system utilizes a configurable machine learning model that enables easy addition, deletion, or editing of evaluation prompts that guide the machine learning model in evaluating the electronic communication interaction from the AI communications bot. In particular, the AI electronic communication system can utilize the evaluation prompts with an electronic communication transcript from the AI communications bot to generate communication analysis objects that represent statistics and/or data on the behavior and/or operation of the AI communications bot. In addition, the AI electronic communication system can utilize the evaluation prompts with an electronic communication transcript from the AI communications bot to trigger digital actions in an inter-network facilitation system from details determined from the electronic communication interaction.

As an example, the AI electronic communication system can generate an electronic transcript from an electronic communication interaction between a first machine learning model (e.g., a communication agent machine learning model) and a user (via a client device). Furthermore, the AI electronic communication system can utilize a second machine learning model (e.g., an electronic communication evaluation machine learning model) to analyze the electronic communication interaction of the first machine learning model (for a set of evaluation prompts). Indeed, the AI electronic communication system can utilize the second machine learning model to generate a communication analysis object (e.g., including metrics from the interaction and/or digital actions). In addition, the AI electronic communication system can trigger one or more digital actions from the generated communication analysis object (to address or respond to a circumstance determined within the electronic communication interaction by the second machine learning model). In some cases, the AI electronic communication system can further display, within a graphical user interface, one or more digital actions and/or communication analysis objects generated from utilizing the second machine learning model with various electronic communication interactions between the first machine learning model and one or more users.

In one or more instances, the AI electronic communication system identifies an electronic communication interaction between an AI communication bot (e.g., a machine learning model) and a user corresponding to a user account of an inter-network facilitation system. For example, the electronic communication interaction can include a support service communication through, but not limited to, voice call, instant messaging, and/or email between the user and the AI communication bot. The AI electronic communication system can generate an electronic transcript from the responses provided by the AI communication bot in the electronic communication interaction between the AI communication bot and the user.

Additionally, in one or more implementations, the AI electronic communication system utilizes a machine learning model to analyze electronic communication interactions of the AI communication bot. In particular, in one or more instances, the AI electronic communication system configures a language model (e.g., a large language model) to utilize a set of evaluation prompts (generated via an administrator device) as instructions to evaluate (or analyze) an input electronic transcript from an electronic communication interaction between an AI communication bot and a user. Indeed, the AI electronic communication system utilizes the evaluation prompts to cause the machine learning model to generate communication analysis objects that can include, but are not limited to, metrics determined from the input electronic communication interaction and/or digital actions to perform in light of the input electronic communication interaction.

For instance, the AI electronic communication system can utilize the machine learning model to generate metrics, such as, but not limited to, bot information relevancy, statistics on the AI communication bot's understanding (e.g., inference) of issues within the electronic communication interaction, and/or statistics on the AI communication bot's ability to follow instructions and/or restrictions configured by an administrator device. In addition, in some cases, the AI electronic communication system can utilize the electronic communication evaluation machine learning model to trigger digital actions from the analysis of the electronic communication interaction. For example, the AI electronic communication system can utilize the machine learning model to trigger digital actions, such as, but not limited to, transmitting electronic notifications, auto suggestions for the inter-network system (or the AI communication bot), configurations, transfers, and/or digital corrections.

Moreover, the AI electronic communication system provides, for display, one or more graphical user interfaces to enable quick, efficient, and easy configuration of the electronic communication evaluation machine learning model. In particular, the AI electronic communication system displays a graphical user interface with selectable options to add, delete, and/or modify evaluation prompts for the machine learning model. In some cases, the AI electronic communication system enables the configuration of the machine learning model via a text box (as the selectable option). In particular, the AI electronic communication system can receive text input in a text box to create an evaluation prompt and add it to the set of evaluation prompts to execute when the machine learning model is utilized to analyze and/or evaluate an electronic communication interaction. For example, the AI electronic communication system can enable the creation, deletion, and/or modification of various evaluation prompts for the machine learning model to utilize, such as, but not limited to, communication check prompts, (AI) behavior check prompts, and/or suggestion check prompts to utilize in the evaluation of an additional electronic communication interaction.

Recent years have seen a significant development in systems that utilize chat bots to manage communications with users of a digital platform. Many existing systems that utilize chat bots attempt to communicate with user autonomously to resolve user questions or issues. Although conventional systems attempt to implement chat bots, such conventional systems often face a number of technical shortcomings, particularly with regard to implementing accurate, efficient, and flexible chat bots.

For example, in many cases, digital platforms handle a large number of user communications (e.g., thousands or millions of queries from users). Oftentimes, due to the substantial number of communications, it is difficult for conventional chat bot systems to track and enforce quality of responses between chat bots and the large number of communications. Furthermore, oftentimes, the extensive number of communications occur in real time and simultaneously on many digital platforms. In such situations, many chat bots and chat bot systems cannot easily and accurately track the quality of conversations generated by the chat bots.

Moreover, such conventional systems often utilize chat bots with rule-based safeguards. In particular, conventional systems often implement rigid rule-based safeguards to control the boundaries of chat bots. Indeed, such rule-based safeguards include hard lists of prohibited terms. In many cases, these rule-based safeguards are difficult to update and often lead to inadvertent effects in which chat bots utilize language and/or communications that are not detected by the rigid rule-based safeguards.

Furthermore, many conventional systems are unable to utilize rule-based safeguards effectively when chat bot systems operate as a black box. In particular, many conventional systems utilize black box chat bots that do not provide technical details on internal decision making and/or architecture. Without discerning these details, many conventional systems are unable to configure or setup accurate rule-based safeguards in communications generated by chat bots.

Moreover, in many instances, conventional chat bot systems are also inefficient. For instance, many conventional chat bot systems utilize rule-based evaluation approaches that cannot react to large number of communications. In many cases, conventional chat bot systems are unable to quickly identify and address issues identified in chat bot communications because rule-based flags often do not provide sufficient information. Due to the inability to react quickly, flags generated by many conventional chat bot systems often provide irrelevant flags and, therefore, result in utilizing computational resources to generate the irrelevant flags.

The AI electronic communication system can provide numerous technical advantages, benefits, and practical applications to relative conventional systems. For example, in contrast to conventional systems that are unable to track a substantial number of chat bot communications, the AI electronic communication system utilizes an electronic communication evaluation machine learning model that can, in parallel, track a large number of electronic communication interactions with accuracy. For instance, the AI electronic communication system utilizes the communication evaluation machine learning model to quickly check against a number of high quality evaluation prompts (in accordance with one or more implementations herein) across many AI communication bot interactions (in real time or near-real time).

Furthermore, unlike conventional chat bot systems that utilize rule-based systems, the AI electronic communication system utilizes evaluation prompts that enable an electronic communication evaluation machine learning model to accurately and flexibly adapt to various communications. Indeed, the AI electronic communication system utilizes an electronic communication evaluation machine learning model that is capable of using open-ended safeguards and automatically updating safeguards to evaluate and catch issues in AI communication interactions that are often missed by rule-based systems. By utilizing open-ended safeguards, through a large language model with evaluation prompts, the AI electronic communication system can quickly check against identify a greater spectrum of issues (e.g., terminology usage, behavioral traits, suggestions, metrics) identified in AI communication bot interactions. Furthermore, the AI electronic communication system can enable the electronic communication evaluation machine learning model to change and/or configure safeguards as issues or social norm behavior changes are detected. Indeed, the AI electronic communication system can enable accurate evaluations and safeguards to AI communication bot generated communications.

Moreover, the AI electronic communication system can accurately utilize the electronic communication evaluation machine learning model on black box AI communication bots. In particular, by checking for a broader spectrum of behavior (instead of rule-based situations), the electronic communication evaluation machine learning model can utilize evaluation prompts with responses generated by black box AI communication bots. In particular, the AI electronic communication system can utilize the electronic communication evaluation machine learning model to evaluate outputs against the broad range of evaluation prompts without considering specific flags or rules that need to be configured for a black box AI communication bot.

Additionally, the AI electronic communication system is also efficient. For instance, unlike many conventional chat bot systems that utilize rule-based evaluation approaches that cannot react to large number of communications, the electronic communication evaluation machine learning model can detect and automatically trigger digital actions in response to communication interactions of an AI communication bot. Indeed, due to its reactive capability, the electronic communication evaluation machine learning model can quickly provide relevant flags and/or reactions to communication interactions of an AI communication bot.

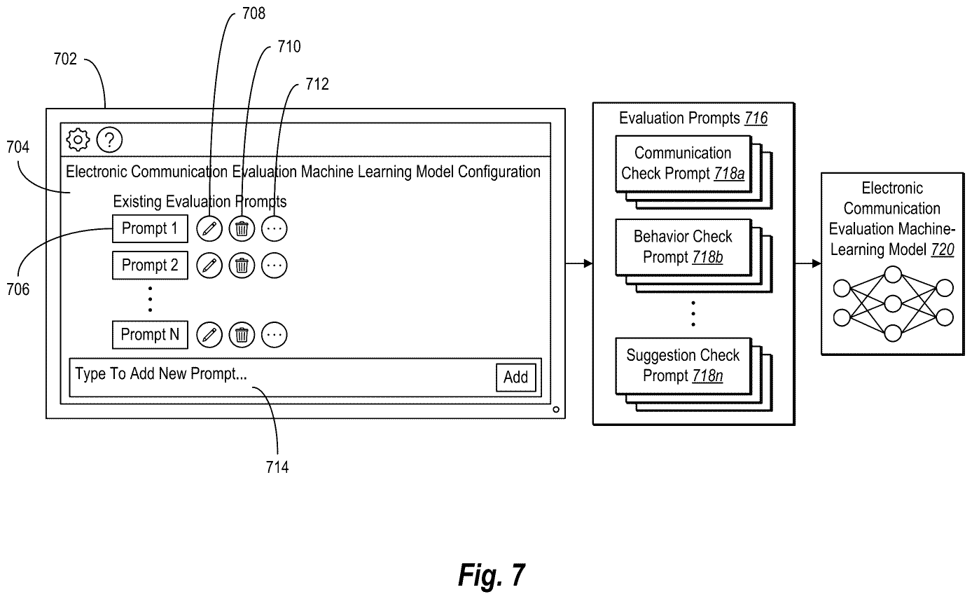

In addition, the AI electronic communication system also enables for improved configuration of an electronic communication evaluation machine learning model. In particular, the AI electronic communication system can quickly modify or add evaluation prompts to utilize with the electronic communication evaluation machine learning model via easy to navigate (and configure) user interface elements. For instance, the AI electronic communication system enable the configuration of the electronic communication evaluation machine learning model by simply adding text-based evaluation prompts for the electronic communication evaluation machine learning model to perform while evaluating communication interactions of an AI communication bot. Indeed, the AI electronic communication system enables quick and efficient configuration of the electronic communication evaluation machine learning model (as described in FIG. 7).

As indicated by the foregoing discussion, the present disclosure utilizes a variety of terms to describe features and advantages of the AI electronic communication system. For example, as used herein, the term “electronic communication interaction” refers to an exchange of information utilizing electronic devices between a user of the inter-network facilitation system and a communication agent machine learning model (or an agent of the inter-network facilitation system). For example, an electronic communication interaction can include messaging interactions or exchanges, email interactions or exchanges, voice call interactions or exchanges, and/or video call interactions or exchanges between one or more users of the inter-network facilitation system and a communication agent machine learning model (or an agent of the inter-network facilitation system).

In some instances, the electronic communication interaction can include an electronic transcript generated from an electronic communication. As used herein, an “electronic transcript” includes a digital record of an electronic communication interaction. In particular, an electronic transcript can include digital text that captures spoken and/or written interactions within an electronic communication interaction. For example, an electronic transcript can include structured or unstructured data capturing a communication in a communication interaction within various file formats (e.g., a PDF file, text file, JSON object).

As used herein, the term “machine learning model” refers to a computer model that can be trained (e.g., tuned or learned) based on inputs to approximate unknown functions and corresponding outputs. As an example, a machine learning model can include, but is not limited to, convolutional neural networks, recurrent neural networks, generative adversarial neural networks), residual neural networks, diffusion models, or a combination thereof. Additionally, a machine learning model can also include, but is not limited to one or more large language models, Term Frequency Inverse Document Frequency (TF-IDF) encoders, Word2Vecs, matrix factorization vector learning approaches, local context window vector learning approaches, Global Vectors for Word Representation (GloVe), Bidirectional Encoder Representations from Transformers, large language models, natural language processing approaches (e.g., spaCy), and/or generative pre-trained transformer models.

In some cases, a machine learning model includes a large language model. For instance, a large language model can include a machine learning model trained to learn patterns and rules of language for summarizing and/or generating digital content. Examples of large language model include BLOOM, Bard AI, ChatGPT (e.g., GPT-3, GPT-4, etc.), LaMDA, and/or DialoGPT.

Additionally, as used herein, the term “electronic communication evaluation machine learning model” refers to a machine learning model (or large language model) that generates electronic communications from a prompt instructing to evaluate communication interactions between users and a communication agent machine learning model (e.g., an AI communication bot). For example, the electronic communication evaluation machine learning model utilizes one or more prompts to generate a communication analysis object (e.g., responsive electronic communications, digital actions, metrics, suggestions) by following or performing tasks outlined in the one or more prompts. In one or more instances, the electronic communication evaluation machine learning model includes a machine learning model (e.g., a large language model) trained and/or fine-tuned to generate electronic communications from a prompt (e.g., an evaluation prompt and/or one or more electronic communication interactions).

As used herein, the term “AI communication bot” can include a computer-based agent capable of responding to user queries within a digital communication interface (e.g., messages, emails, voice calls). In some cases, the AI communication bot can include a communication agent machine learning model. Indeed, the AI communication bot can include a communication agent machine learning model trained to generate responses to user queries received within a communication interface. For instance, the AI communication bot can include a large language model-based communication agent machine learning model. In some cases, the AI communication bot can further include rule-based response systems and/or decision tree-based response systems.

As used herein, the term “evaluation prompt” refers to instructional prompts to a machine learning model (e.g., a large language model) that represent a question to answer for an electronic communication interaction and/or task to perform in relation to the electronic communication interaction. For example, an evaluation prompt can include prompts posing particular questions for a machine learning model (e.g., whether the AI communication bot providing relevant information, whether the AI communication bot is using offensive language, whether the AI communication bot is understanding user issues) to check for in an electronic communication interaction. Additionally, an evaluation prompt can include instructions to perform particular actions, such as, but not limited to, flagging offensive language, generating suggestions, and/or configuring the AI communications bot. In addition, an evaluation prompt can include, but is not limited to, communication check prompts, behavior check prompts, and/or suggestion check prompts (as described herein).

As used herein, the term “communication analysis object” refers to a data object generated by an electronic communication evaluation machine learning model to represent one or more evaluation answers, digital actions, and/or metrics determined from an electronic communication interaction. For instance, the communication analysis object can include one or more evaluation answers to evaluation prompt questions posed to the electronic communication evaluation machine learning model while evaluating an electronic communication interaction of an AI communication bot. Furthermore, the communication analysis object can include one or more metrics determined for the electronic communication interaction of an AI communication bot by the electronic communication evaluation machine learning model. In addition, the communication analysis object can include one or more digital actions and/or suggestions determined by the electronic communication evaluation machine learning model from the electronic communication interaction of the AI communication bot.

In addition, as used herein, the term “digital action” refers to a task performed by an electronic communication evaluation machine learning model and/or the inter-network facilitation system in response to an electronic communication interaction of an AI communication bot. For example, a digital action can include an electronic notification, an auto suggestion, a configuration, a transfer, and/or a digital correction.

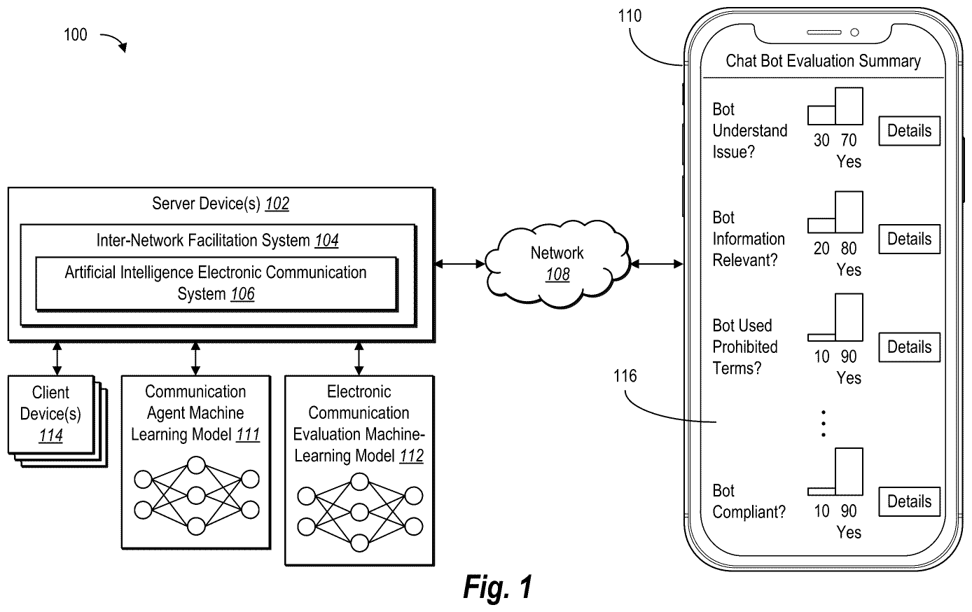

Turning now to the figures, FIG. 1 illustrates a block diagram of a system 100 (or system environment) for implementing an inter-network facilitation system 104 and an artificial intelligence (AI) electronic communication system 106 in accordance with one or more embodiments. As shown in FIG. 1, the system 100 includes server device(s) 102 (which includes the inter-network facilitation system 104 and the AI electronic communication system 106), administrator device 110, client device(s) 114, a communication agent machine learning model 111, and an electronic communication evaluation machine learning model 112. As further illustrated in FIG. 1, the server device(s) 102, the client device(s) 114, and the administrator device 110 can communicate via the network 108.

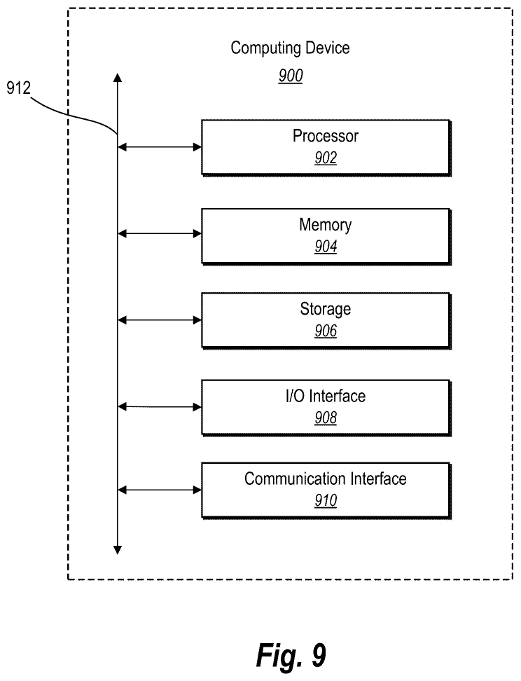

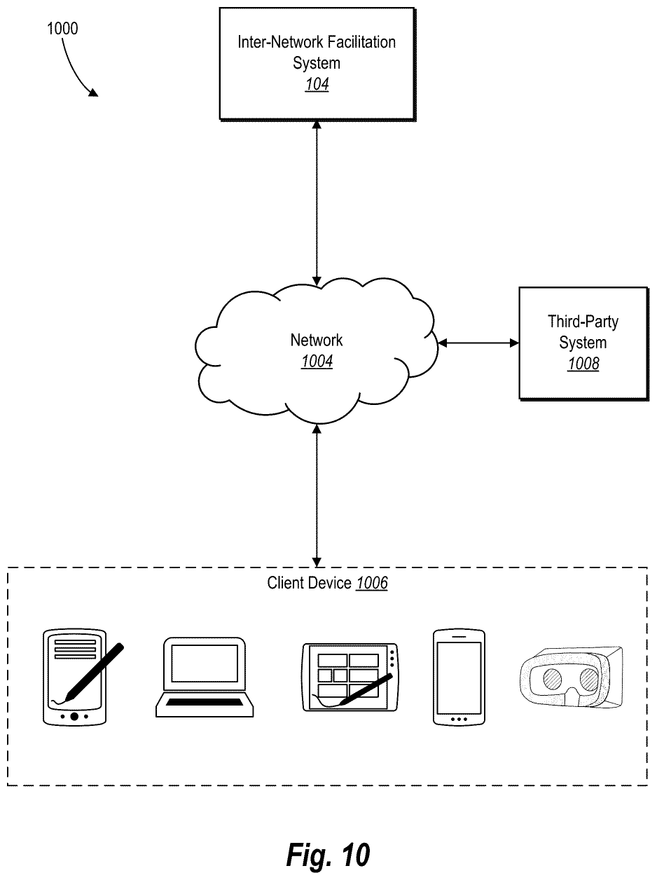

Although FIG. 1 illustrates the AI electronic communication system 106 being implemented by a particular component and/or device within the system 100, the AI electronic communication system can be implemented, in whole or in part, by other computing devices and/or components in the system 100 (e.g., the administrator device 110). Additional description regarding the illustrated computing devices (e.g., the server device(s) 102, computing devices implementing the AI electronic communication system 106, the client device(s) 114, the administrator device 110, and/or the network 108) is provided with respect to FIGS. 9 and 10 below.

As shown in FIG. 1, the server device(s) 102 can include the inter-network facilitation system 104. In some embodiments, the inter-network facilitation system 104 can determine, store, generate, and/or display financial information corresponding to a user account (e.g., a banking application, a money transfer application). Furthermore, the inter-network facilitation system 104 can also electronically communicate (or facilitate) financial transactions between one or more user accounts (and/or computing devices). Moreover, the inter-network facilitation system 104 can also track and/or monitor financial transactions and/or financial transaction behaviors of a user within a user account.

The inter-network facilitation system 104 can include a system that comprises the AI electronic communication system 106 and that facilitates financial transactions and digital communications across different computing systems over one or more networks. For example, the inter-network facilitation system 104 manages credit accounts, secured accounts, and other accounts for one or more accounts registered within the inter-network facilitation system 104. In some cases, the inter-network facilitation system 104 is a centralized network system that facilitates access to online banking accounts, credit accounts, and other accounts within a central network location. Indeed, the inter-network facilitation system 104 can link accounts from different network-based financial institutions to provide information regarding, and management tools for, the different accounts.

In one or more embodiments, the AI electronic communication system 106 generates digital actions and/or electronic communication analysis objects by utilizing a machine learning model to analyze an electronic communication interaction between an AI communication (chat) bot and a user. For instance, the AI electronic communication system 106 can receive configurations (e.g., a set of evaluation prompts) from the administrator device 110. Furthermore, the AI electronic communication system 106 can identify an electronic communication interaction between a client device from the client device(s) 114 (e.g., a client device of a user account) and the communication agent machine learning model 111. In addition, the AI electronic communication system 106 can utilize the electronic communication evaluation machine learning model 112 with the electronic communication interaction to generate one or more communication analysis objects (which can include digital actions) for the electronic communication interaction (in accordance with one or more implementations herein).

Furthermore, although not shown in FIG. 1, the system 100 can include one or more data sources. For example, the one or more data sources can manage and/or store various data for the inter-network facilitation system 104, the client device(s) 114, the administrator device 110, the communication agent machine learning model 111, and the electronic communication evaluation machine learning model 112. Indeed, the one or more data sources can include various data services or data repositories (e.g., via hardware and/or software) that manage data storage via cloud-based services and/or other networks (e.g., offline data stores, online data stores).

As also illustrated in FIG. 1, the system 100 includes the administrator device 110. For example, the administrator device 110 may include, but are not limited to, mobile devices (e.g., smartphones, tablets) or other type of computing devices, including those explained below with reference to FIGS. 9 and 10. Additionally, the administrator device 110 can include computing devices associated with (and/or operated by) administrators for the inter-network facilitation system 104. Moreover, the system 100 can include various numbers of administrator devices that communicate and/or interact with the inter-network facilitation system 104 and/or the artificial intelligence electronic communication system 106.

Furthermore, as shown in FIG. 1, the administrator device 110 can include an administrator application 116. The administrator application 116 can include instructions that (upon execution) cause the administrator device 110 to perform various actions. For example, a user can interact with the administrator application 116 on the administrator device 110 to configure the electronic communication evaluation machine learning model 112 (in accordance with one or more implementations herein) and/or the communication agent machine learning model 111. In addition, the administrator device 110, via the administrator application 116, can display one or more communication analysis objects and/or digital actions generated by the electronic communication evaluation machine learning model 112 (as shown in FIG. 1).

Additionally, as shown in FIG. 1, the system 100 also includes the client device(s) 114. In certain instances, the client device(s) 114 may include, but is not limited to, a mobile device (e.g., smartphone, tablet) or other type of computing device, including those explained below with reference to FIGS. 9 and 10. Additionally, the client device(s) 114 can include a computing device associated with (and/or operated by) a user corresponding to a user account for the inter-network facilitation system 104. Moreover, the system 100 can include various numbers of client devices that communicate and/or interact with the inter-network facilitation system 104 and/or the artificial intelligence electronic communication system 106. Indeed, the client device(s) 114 can initiate and conduct electronic communication interactions with the communication agent machine learning model 111 (as described herein).

In certain instances, the client device(s) 114 corresponds to one or more user accounts (e.g., user accounts stored at the server device(s) 102). For instance, a user of a client device can establish a user account with login credentials and various information corresponding to the user. In addition, the user accounts can include a variety of information regarding financial information and/or financial transaction information for users (e.g., name, telephone number, address, bank account number, credit amount, debt amount, financial asset amount), payment information (e.g., account numbers), transaction history information, and/or contacts for financial transactions. In some embodiments, a user account can be accessed via multiple devices (e.g., multiple client devices) when authorized and authenticated to access the user account within the multiple devices. Moreover, the client device(s) 114 can, via a user account, access financial information, initiate a financial transaction (e.g., transfer money to another account, deposit money, withdraw money), and/or access or provide data (to the server device(s) 102).

The present disclosure utilizes client devices to refer to devices associated with such user accounts. In referring to a client (or user) device, the disclosure and the claims are not limited to communications with a specific device, but any device corresponding to a user account of a particular user. Accordingly, in using the term client device, this disclosure can refer to any computing device corresponding to a user account of the inter-network facilitation system 104.

As further shown in FIG. 1, the system 100 includes the communication agent machine learning model 111. For instance, the communication agent machine learning model 111 can interact with the client device(s) 114 (e.g., users of the client device(s) 114) to respond to inquiries and/or communications from the client device(s) 114 to generate electronic communication interactions (in accordance with one or more implementations herein). Furthermore, as also shown in FIG. 1, the system 100 includes the electronic communication evaluation machine learning model 112. For example, the electronic communication evaluation machine learning model 112 can utilize the electronic communication interactions generated by the communication agent machine learning model 111 (with evaluation prompts from the administrator device 110) to evaluate the responses of the communication agent machine learning model 111 and trigger digital actions and/or generate communication analysis objects (in accordance with one or more implementations herein).

As further shown in FIG. 1, the system 100 includes the network 108. As mentioned above, the network 108 can enable communication between components of the system 100. In one or more embodiments, the network 108 may include a suitable network and may communicate using a various number of communication platforms and technologies suitable for transmitting data and/or communication signals, examples of which are described with reference to FIG. 10. Furthermore, although FIG. 1 illustrates the server device(s) 102, the client device(s) 114, and the administrator device 110 communicating via the network 108, the various components of the system 100 can communicate and/or interact via other methods (e.g., the server device(s) 102 and the client device 114 can communicate directly).

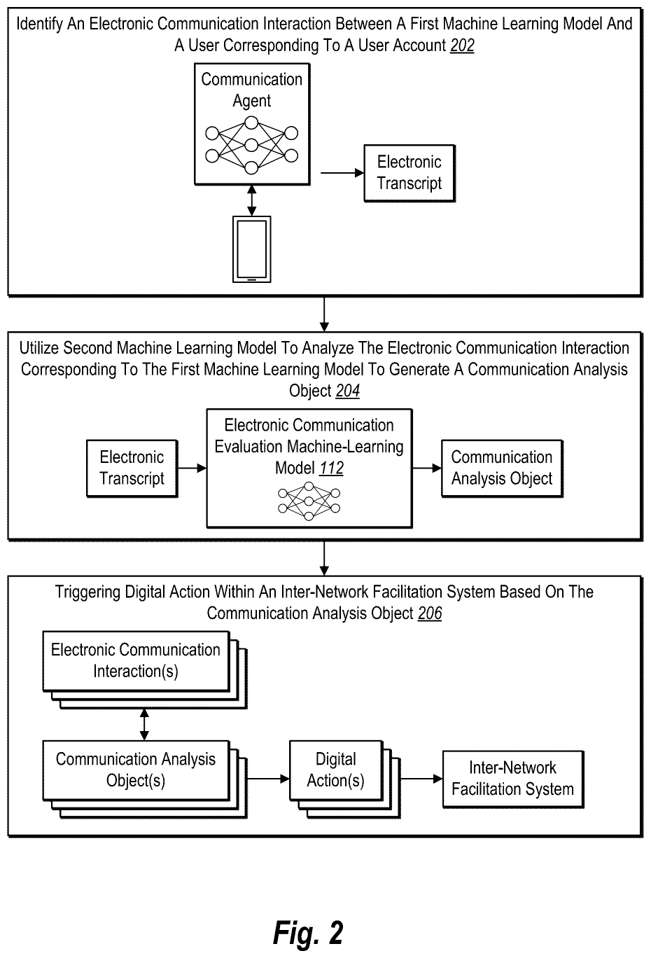

As mentioned above, the AI electronic communication system 106 can utilize machine learning to evaluate an electronic communication interaction between an artificial intelligence communication (chat) bot and a user of a user account. For instance, FIG. 2 illustrates the AI electronic communication system 106 utilizing machine learning to evaluate an electronic communication interaction between an artificial intelligence communication (chat) bot and a user of a user account. In particular, FIG. 2 illustrates the AI electronic communication system 106 identifying an electronic communication interaction between a first machine learning model and a user corresponding to a user account, utilizing a second machine learning model to analyze the electronic communication interaction corresponding to the first machine learning model to generate a communication analysis object, and triggering a digital action within an inter-network facilitation system based on the communication analysis object.

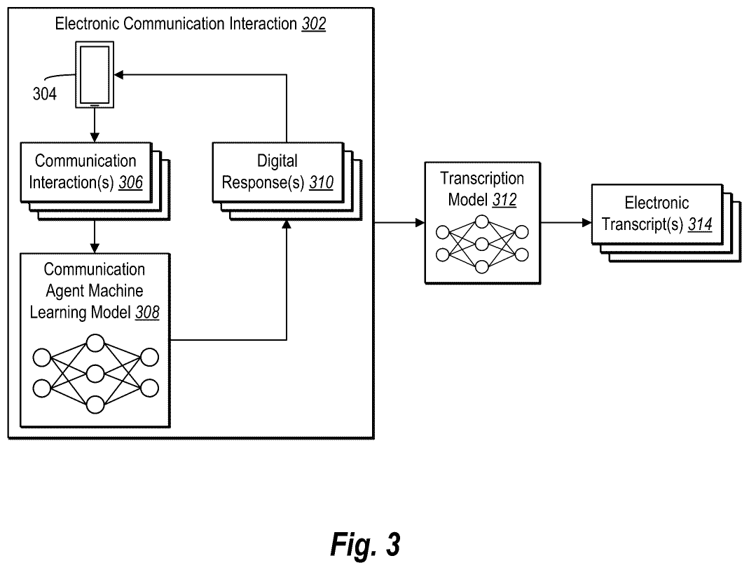

To illustrate, as shown in an act 202 of FIG. 2, the AI electronic communication system 106 identifies an electronic communication interaction between a first machine learning model and a user corresponding to a user account. For example, the AI electronic communication system 106 can enable the first machine learning model (e.g., an AI communication bot) to interact with a user of a client device to generate an electronic communication interaction (e.g., via voice call, SMS, email). Moreover, in one or more implementations, the AI electronic communication system 106 generates an electronic transcript from the electronic communication interaction. Indeed, the AI electronic communication system identifying an electronic communication interaction is described in greater detail below (e.g., in reference to FIG. 3).

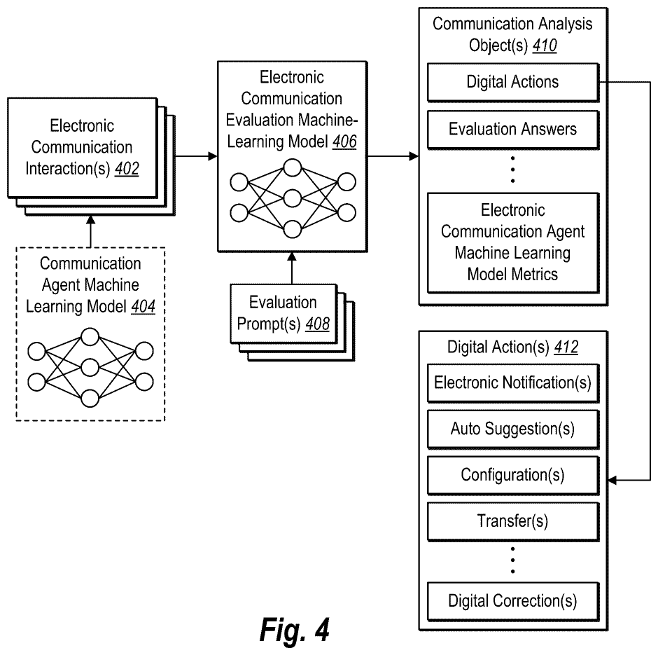

In addition, as shown in an act 204 of FIG. 2, the AI electronic communication system 106 utilizes a second machine learning model to analyze the electronic communication interaction corresponding to the first machine learning model to generate a communication analysis object. For instance, the AI electronic communication system 106 can utilize, as the second machine learning model, a language model with one or more configurable input evaluation prompts to cause the second machine learning model to execute an evaluation of an input electronic transcript (using the evaluation prompts). Furthermore, the AI electronic communication system 106 can utilize the electronic communication evaluation machine learning model to generate communication analysis objects that indicate one or more metrics from the electronic communication interaction between the first machine learning model and a user of a client device. In addition, in one or more instances, the AI electronic communication system 106 can also trigger digital actions determined by the second machine learning model (e.g., included in the communication analysis object). For instance, the AI electronic communication system 106 utilizing a second machine learning model to evaluate a first model that communicates with users to generate communication analysis objects and/or trigger digital actions as described in greater detail below (e.g., in reference to FIG. 4). In addition, the AI electronic communication system 106 can enable configuration of evaluation prompts to utilize with the electronic communication evaluation machine learning model as described in greater detail below (e.g., in reference to FIG. 7).

Furthermore, as shown in an act 206 of FIG. 2, the AI electronic communication system 106 triggers a digital action within an inter-network facilitation system based on the communication analysis object. In particular, the AI electronic communication system 106 can utilize communication analysis object(s) generated for electronic communication interaction(s) (from the electronic communication evaluation machine learning model) to identify one or more digital actions to perform in response to the electronic communication interaction(s). For example, the electronic communication evaluation machine learning model can identify and execute one or more digital actions in response to an electronic communication interaction, such as, but not limited to, transmitting notifications, automated suggestions, configurations, transfers, and/or digital corrections. Indeed, the AI electronic communication system 106 can trigger a digital action as described in greater below (e.g., in relation to FIGS. 4-6).

As mentioned above, the AI electronic communication system 106 can identify electronic communication interactions between an AI communications bot and one or more users corresponding to user accounts. For instance, FIG. 3 illustrates the AI electronic communication system 106 identifying electronic communication interactions. As shown in FIG. 3, the AI electronic communication system 106 identifies an electronic communication interaction 302. In particular, as shown in FIG. 3, the AI electronic communication system 106 identifies communication interaction(s) 306 (e.g., user input text, user selections, voice data) from a client device 304 (e.g., operated by a user) transmitted to a communication agent machine learning model 308. In addition, the AI electronic communication system 106 also identifies digital response(s) 310 to the communication interaction(s) 306 transmitted to the client device 304 by the communication agent machine learning model 308. In one or more instances, the AI electronic communication system 106 utilizes the collection of communication interaction(s) 306 from the client device 304 and the digital response(s) 310 from the communication agent machine learning model 308 as an electronic communication interaction 302.

In some instances, the AI electronic communication system 106 further generates electronic transcripts (or other unstructured and/or structured data) from the electronic communication interactions. For example, as shown in FIG. 3, the AI electronic communication system 106 utilizes a transcription model 312 with a transcription model 312 to generate electronic transcript(s) 314 from the electronic communication interaction 302. For instance, the AI electronic communication system 106 can generate an electronic transcript as text data from a voice call between a client device (of a user) and the communication agent machine learning model. In some cases, the AI electronic communication system 106 can generate the electronic transcript as a text log from an instant message interaction and/or an email interaction between a client device (of a user) and the communication agent machine learning model. In some implementations, the AI electronic communication system 106 can generate machine readable data as an electronic transcript (e.g., a binary representation of the electronic communication interaction between the client device (of a user) and the communication agent machine learning model). Additionally, the AI electronic communication system 106 can utilize a transcription model, such as, but not limited to, a verbatim transcription model, a phonetic transcription model, and/or an intelligent verbatim transcription model.

For example, in one or more instances, the AI electronic communication system 106 can identify electronic communication interactions from instant message interactions between a client device (of a user) and the communication agent machine learning model. In particular, the AI electronic communication system 106 can identify electronic messages from a user of a client device and electronic messages generated by the communication agent machine learning model (as a response). For instance, the electronic communication interactions can include messages, such as, but not limited to, instant messages in an instant messaging application, SMS messages, and/or rich communication service (RCS) messages.

In some implementations, the AI electronic communication system 106 can identify electronic communication interactions from voice data from a voice (or video) call between a client device (of a user) and the communication agent machine learning model. In particular, the AI electronic communication system 106 can identify voice data packages from a user of a client device and/or generated by the communication agent machine learning model (as a response). For instance, the electronic communication interactions can include, but is not limited to, voice calls and/or video calls.

In some cases, the AI electronic communication system 106 can identify electronic communication interactions from email interactions between a client device (of a user) and the communication agent machine learning model. For example, the AI electronic communication system 106 can identify an email thread from emails generated by the client device (of a user) and/or the communication agent machine learning model.

Furthermore, the AI electronic communication system 106 can utilize a communication agent machine learning model that generates responses to queries (or communications) provided by a user of a user account. For example, the AI electronic communication system 106 can utilize a communication agent machine learning model that generates language responses to prompts. For example, the communication agent machine learning model can include a large language model and/or a rule-based communication bot (as described above).

In some implementations, the AI electronic communication system 106 utilizes a communication agent machine learning model from a third party system. In particular, the AI electronic communication system 106 can utilize a communication agent machine learning model that is a black box system to the AI electronic communication system 106 (e.g., without access to the technical details and/or architecture of the communication agent machine learning model). Indeed, in one or more instances, the AI electronic communication system 106 utilizes user provided electronic communications as input into the black-box communication agent machine learning model to receive an output response (as a digital response for the electronic communication interaction).

Although one or more embodiments herein describe the AI electronic communication system 106 identifying a singular electronic communication interaction between a client device (of a user) and a communication agent machine learning model, the AI electronic communication system 106 can identify multiple electronic communication interactions. For instance, the AI electronic communication system 106 can identify various numbers of electronic communication interactions (e.g., thousands, millions) between various numbers of client devices and the communication agent machine learning model (or multiple communication agent machine learning model operating in parallel).

As mentioned above, the AI electronic communication system 106 can utilize machine learning to evaluate an electronic communication interaction between an artificial intelligence communication (chat) bot and a user of a user account. For instance, FIG. 4 illustrates the AI electronic communication system 106 utilizing a machine learning model to evaluate a communication interaction between an artificial intelligence communication (chat) bot and a user of a user account. In particular, as shown in FIG. 4, the AI electronic communication system 106 utilizes a set of evaluation prompts that instruct an electronic communication evaluation machine learning model to evaluate electronic communication interactions of a communication agent machine learning model to generate communication analysis objects (and, further, digital actions).

As shown in FIG. 4, the AI electronic communication system 106 identifies an electronic communication interaction(s) 402. In some instances, the AI electronic communication system 106 identifies the electronic communication interaction(s) 402 from a communication agent machine learning model 404. Indeed, the AI electronic communication system 106 can identify electronic communication interaction(s) 402 in accordance with one or more implementations herein.

Furthermore, as shown in FIG. 4, the AI electronic communication system 106 can utilize the electronic communication interaction(s) 402 with an electronic communication evaluation machine learning model 406. As further shown in FIG. 4, the AI electronic communication system 106 utilizes an evaluation prompt(s) 408 with the electronic communication evaluation machine learning model 406 as a prompt to instruct the electronic communication evaluation machine learning model 406 to analyze the electronic communication interaction(s) 402. In one or more instances, the AI electronic communication system 106 utilizes the evaluation prompt(s) 408 to instruct the electronic communication evaluation machine learning model 406 to generate a particular response and/or digital action (for a communication analysis object) considering the particular electronic communication interaction(s) 402.

For example, as shown in FIG. 4, the AI electronic communication system 106 utilizes the evaluation prompt(s) 408 and the electronic communication interaction(s) 402 with the electronic communication evaluation machine learning model 406 to generate a communication analysis object(s) 410. Indeed, as shown in FIG. 4, the AI electronic communication system 106 can utilize the electronic communication evaluation machine learning model 406 to generate (from the electronic communication interaction(s) 402) the communication analysis object(s) 410 with components, such as, but not limited to, digital actions, evaluation answers (e.g., answers to questions about the electronic communication interactions and/or metrics for the electronic communication interactions), and/or electronic communication agent machine learning model metrics. As further shown in FIG. 4, the AI electronic communication system 106 can utilize the electronic communication evaluation machine learning model 406 to generate (or determine) specific digital action(s) 412 for the electronic communication interaction(s) 402, such as, but not limited to, electronic notification(s), auto suggestion(s), configuration(s), transfer(s), and/or digital correction(s).

In one or more instances, the AI electronic communication system 106 can utilize one or more evaluation prompts with the electronic communication evaluation machine learning model to generate one or more communication analysis objects. Indeed, in one or more implementations, the AI electronic communication system 106 utilizes multiple evaluation prompts to cause the electronic communication evaluation machine learning model to generate multiple components of the communication analysis objects. As an example, the AI electronic communication system 106 can utilize various combinations of evaluation prompts, such as, but not limited to, communication check prompts, behavior check prompts, and/or suggestion check prompts (as described in greater detail in FIG. 7).

Furthermore, the AI electronic communication system 106 also utilizes (e.g., as input) an electronic communication interaction with the electronic communication evaluation machine learning model. For instance, the AI electronic communication system 106 can utilize an electronic transcript corresponding to the electronic communication interaction as an input prompt for the electronic communication evaluation machine learning model. In some cases, the AI electronic communication system 106 provides an entire electronic transcript as data to the electronic communication evaluation machine learning model (e.g., instructing the electronic communication evaluation machine learning model to read a full electronic transcript from the electronic communication interaction and evaluate the interaction based on the evaluation prompts).

In one or more embodiments, the AI electronic communication system 106 can utilize the electronic communication evaluation machine learning model to generate (or determine) digital actions (as part of the communication analysis object) for a particular electronic communication interaction. For instance, the AI electronic communication system 106 can enable the electronic communication evaluation machine learning model (via an evaluation prompt) to trigger a digital action in response to a certain criterion (or circumstance) identified in the electronic communication interaction.

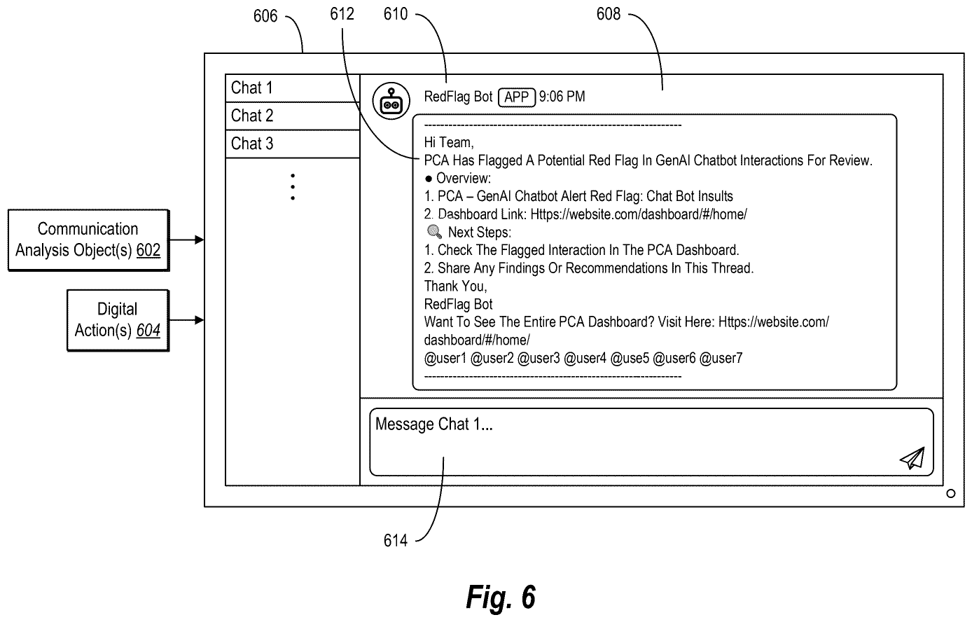

For example, in some instances, the AI electronic communication system 106 can trigger a digital action for an electronic notification. In particular, the AI electronic communication system 106 can generate an electronic notification indicating a particular circumstance identified (or flagged) in the electronic communication interaction. As an example, the AI electronic communication system 106 can, via the electronic communication evaluation machine learning model, identify a particular circumstance or scenario within the electronic communication interaction (e.g., the AI communication bot utilizing offensive language, utilizing a prohibited term, operating outside of regulations corresponding to the inter-network facilitation system, a failure to resolve a user issue). In response to identifying the particular circumstance or scenario, the AI electronic communication system 106 can trigger, via the electronic communication evaluation machine learning model, the transmittal of an electronic notification to one or more administrator devices with information indicating the identified circumstance or scenario (e.g., as described in FIG. 6). Indeed, the AI electronic communication system 106 can generate and transmit electronic notifications, such as, but not limited to, a message alert, an email alert, a push notification, and/or a voice call alert.

In some implementations, the AI electronic communication system 106 can trigger an auto suggestion as a digital action. For example, the AI electronic communication system 106 can identify, via the electronic communication evaluation machine learning model, a technical flaw identified in the inter-network facilitation system (e.g., a bug, a broken link, a calculation error) through the electronic communication interaction (e.g., a user and communication agent machine learning model discussing a technical flaw). In addition, the AI electronic communication system 106 can trigger an auto suggestion that describes (e.g., via an electronic notification) the technical flaw. In some cases, the AI electronic communication system 106 can trigger (via the electronic communication evaluation machine learning model) an auto suggestion action to implement a fix to the technical problem and/or generate instructions (for an administrator) to fix the technical problem.

In some instances, the AI electronic communication system 106 can generate a technical support ticket as a digital action. For instance, the AI electronic communication system 106 can identify, via the electronic communication evaluation machine learning model, a technical flaw and/or a user issue (as described above) with the inter-network facilitation system and/or user account. Moreover, the AI electronic communication system 106 the AI electronic communication system 106 can generate, via the electronic communication evaluation machine learning model, a technical support ticket (e.g., within a developer dashboard) for the identified technical flaw and/or a user issue.

In one or more embodiments, the AI electronic communication system 106 can identify, via the electronic communication evaluation machine learning model, a user account error identified in the inter-network facilitation system (e.g., incorrect user account information, incorrect logging of user activities, incorrect user network transactions) through the electronic communication interaction (e.g., via a user and communication agent machine learning model discussing a user account error). Moreover, the AI electronic communication system 106 can trigger an auto suggestion that describes (e.g., via an electronic notification) the user account error. In some implementations, the AI electronic communication system 106 can trigger (via the electronic communication evaluation machine learning model) an auto suggestion action to implement a fix to the user account error and/or generate instructions (for an administrator) to fix the user account error.

In some instances, the AI electronic communication system 106 can identify, via the electronic communication evaluation machine learning model, a particular user query from the user corresponding to the electronic communication interaction. For example, the user query can include, but is not limited to, a request for instructions on accessing or utilizing specific functionalities of the inter-network facilitation system and/or request for answers to specific inquiries about the user account on the inter-network facilitation system. The AI electronic communication system 106 can trigger (via the electronic communication evaluation machine learning model) an auto suggestion that describes (e.g., via an electronic notification) the user inquiry. In some implementations, the AI electronic communication system 106 can further trigger (via the electronic communication evaluation machine learning model) an auto suggestion action to suggest an answer to the user inquiry for the AI communication bot (to provide in the electronic communication interaction) when the AI communication bot is unable to determine and/or generate an answer to the user inquiry.

Furthermore, in one or more implementations, the AI electronic communication system 106 can trigger a model configuration as a digital action. For example, the AI electronic communication system 106 can identify (via the electronic communication evaluation machine learning model) a flaw or shortcoming of the communication agent machine learning model (from the electronic communication interaction). As an example, the AI electronic communication system 106 can identify (via the electronic communication evaluation machine learning model) that the communication agent machine learning model is incorrectly functioning by, but not limited to, providing incorrect answers, misunderstanding queries, and/or responding with irrelevant information. The AI electronic communication system 106 can determine (via the electronic communication evaluation machine learning model) a modification to parameters of the communication agent machine learning model to resolve the incorrect functionality (e.g., modifications to settings, thresholds, and/or tolerances) of the communication agent machine learning model. In addition, the AI electronic communication system 106 can trigger (via the electronic communication evaluation machine learning model) a digital action to modify the parameters of the communication agent machine learning model based on the determined resolution for the incorrect functionality.

Additionally, the AI electronic communication system 106 can trigger a communication transfer as a digital action. For example, the AI electronic communication system 106 can identify (via the electronic communication evaluation machine learning model) that the communication agent machine learning model (in the electronic communication interaction) is unable to resolve the user request. The AI electronic communication system 106 can determine (via the electronic communication evaluation machine learning model) that a live agent should intervene to resolve the user request instead of the communication agent machine learning model. In response, the AI electronic communication system 106 can trigger (via the electronic communication evaluation machine learning model) a digital action to transfer the communication stream (e.g., the phone call, video call, messaging thread, email thread) of the user of the user account to a live agent of the inter-network facilitation system (e.g., a customer service representative agent).

Moreover, the AI electronic communication system 106 can trigger a digital correction as a digital action. For instance, the AI electronic communication system 106 can identify (via the electronic communication evaluation machine learning model) that the communication agent machine learning model (in the electronic communication interaction) has responded with incorrect information. In response, the AI electronic communication system 106 can modify or correct (via the electronic communication evaluation machine learning model) the identified incorrect information. For example, the AI electronic communication system 106 can utilize the electronic communication evaluation machine learning model to intervene and provide a digital correction within the electronic communication interaction. In some cases, the AI electronic communication system 106 can utilize the electronic communication evaluation machine learning model to transmit an electronic notification to the user of the user account to notify the user of the incorrect information.

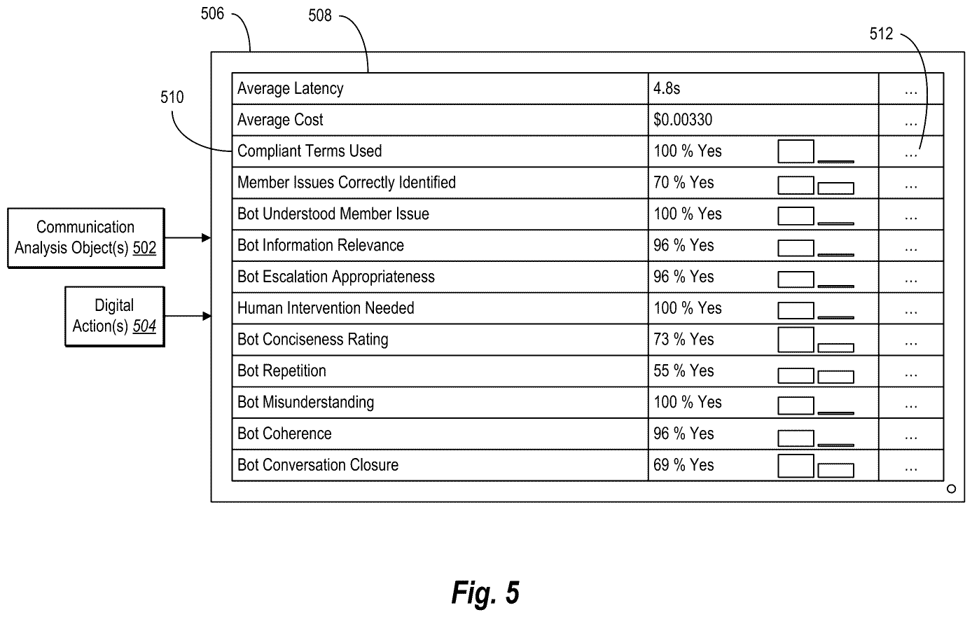

As further shown in FIG. 4, the AI electronic communication system 106 can generate (via the electronic communication evaluation machine-learning model) evaluation answers for one or more evaluation prompts based on an electronic communication interaction. For example, the AI electronic communication system 106 can utilize, as an evaluation prompt, a specific question for the electronic communication evaluation machine learning model in relation to the electronic communication interaction. For instance, the evaluation prompt can include, but is not limited, questions of whether a particular action was taken by the AI communication bot during the communication interaction (e.g., was a specific product mentioned, was a specific resource mentioned), whether a user query was answered with relevant information by the AI communication bot, and/or whether a specific sentiment was used by the AI communication bot. Indeed, the electronic communication evaluation machine learning model can generate an evaluation answer to the evaluation prompts by analyzing the electronic communication interaction to determine an answer to one or more questions (e.g., as shown in FIG. 5).

In addition, in one or more instances, the AI electronic communication system 106 utilizes the electronic communication evaluation machine learning model to generate metrics for the electronic communication agent machine learning model (and/or other types of AI communication bots). For instance, the AI electronic communication system 106 can utilize the electronic communication evaluation machine learning model to track particular metrics for the AI communication bot, such as, but not limited to, latency, computational cost, runtime cost, response length, and/or ranking or scoring particular behaviors or actions (e.g., ranking conciseness, ranking sentiments, ranking empathy, ranking grammar). Moreover, the AI electronic communication system 106 can display the metrics for the AI communication bot (for individual electronic communication interactions and/or aggregated from multiple electronic communication interactions).

Although one or more embodiments describe the AI electronic communication system 106 utilizing the electronic communication evaluation machine learning model to generate specific responses and/or answers from analyzing an electronic communication interaction, the AI electronic communication system 106 can utilize the electronic communication evaluation machine learning model to generate a variety of responses, metrics, and/or actions based on an analysis of one or more electronic communication interactions (in accordance with one or more implementations herein).

Furthermore, as mentioned above, the AI electronic communication system 106 can display one or more communication analysis objects generated by the electronic communication evaluation machine learning model. For instance, FIG. 5 illustrates the AI electronic communication system 106 providing, for display within a graphical user interface of an administrator device, one or more communication analysis objects generated by the electronic communication evaluation machine learning model (from analyzing one or more electronic communication interactions).

As shown in FIG. 5, the AI electronic communication system 106 provides, for display within a graphical user interface 508 of a client device 506, one or more communication analysis object(s) 502. In particular, as shown in FIG. 5, the AI electronic communication system 106 displays, within the graphical user interface 508, data from a communication analysis object and a corresponding evaluation prompt for the data. For example, the AI electronic communication system 106 can display an evaluation prompt utilized by the electronic communication evaluation machine learning model and a response generated for the evaluation prompt (e.g., a question and an answer to the question in relation to one or more electronic communication interactions). Indeed, as shown in FIG. 5, the AI electronic communication system 106 displays an element 510 to indicate a particular evaluation prompt (e.g., an evaluation question of whether the AI communication bot avoided terms to maintain compliance with financial institutions) and an answer to the particular evaluation prompt based on the analyzed electronic communication interaction (e.g., yes or no).

Additionally, as shown in FIG. 5, the AI electronic communication system 106 can provide, for display within the graphical user interface 508, a selectable option 512 to access one or more options in relation to a particular communication analysis object. For instance, the AI electronic communication system 106 can enable the selectable option 512 to navigate to additional detail or data generated (or gathered) by the electronic communication evaluation machine learning model for an evaluation prompt and/or evaluation answer in relation to an electronic communication interaction and/or multiple electronic communication interactions. In some implementations, the AI electronic communication system 106 can navigate, via the selectable option, to citations or locations in an electronic transcript of one or more electronic communication interactions related to the particular evaluation prompt and/or evaluation answer (as identified by the electronic communication evaluation machine learning model).

As shown in FIG. 5, the AI electronic communication system 106 displays communication analysis objects aggregated for an AI communication bot from multiple electronic communication interactions. Although shown as aggregated communication analysis objects, the AI electronic communication system 106 can display communication analysis objects generated for an individual electronic communication interaction. To illustrate, in some instances, the AI electronic communication system 106 displays selectable options within a graphical user interface to navigate to evaluation answers and/or metrics generated for a particular electronic communication interaction. For example, the AI electronic communication system 106 can display communication analysis objects corresponding to individual electronic communication interaction.

Indeed, as shown in FIG. 5 and as mentioned above, the AI electronic communication system 106 can utilize the electronic communication evaluation machine learning model to generate metrics for the AI communication bot in relation to one or more electronic communication interactions. For instance, the AI electronic communication system 106 can display metrics, such as, latency, runtime costs, and/or ratings (e.g., conciseness rating). Although one or more embodiments describes or illustrates particular metrics, the AI electronic communication system 106 can generate and utilize a variety of metrics generated by the electronic communication evaluation machine learning model (in accordance with one or more implementations herein).

In addition, as shown in FIG. 5, the AI electronic communication system 106 displays evaluation answers to various evaluation prompts. For example, the AI electronic communication system 106 generates and displays (via the electronic communication evaluation machine learning model) evaluation answers for prompts related to questions on terminology used in the communications, issue identification, issue comprehension, response relevancy, accuracy of escalation, conciseness evaluations, repetition evaluations, bot coherency evaluations, and/or evaluations on whether the bot provides sufficient closure in a communication interaction. Although, FIG. 5 and one or more embodiments herein describe a particular set of evaluation prompts and evaluation answers, the AI electronic communication system 106 can utilize a variety of evaluation prompts (e.g., as questions) to cause the electronic communication evaluation machine learning model to generate a variety of evaluation answers (for one or more electronic communication interactions).

As further shown in FIG. 5, in some implementations, the AI electronic communication system 106 displays a digital action(s) 504 within the graphical user interface 508. For instance, the AI electronic communication system 106 can display a digital action(s) suggested by the electronic communication evaluation machine learning model (in accordance with one or more implementations herein) with a selectable option to trigger or initiate the digital action(s). Upon detecting a user interaction with the selectable option, the AI electronic communication system 106 can trigger or initiate the selected digital action. In some embodiments, the AI electronic communication system 106 can display a digital action(s) triggered by the electronic communication evaluation machine learning model in relation to one or more electronic communication interactions.

Moreover, in some implementations, the AI electronic communication system 106 displays an auto suggestion(s) within a graphical user interface of an administrator device. For example, the AI electronic communication system 106 can display an auto suggestion(s) suggested by the electronic communication evaluation machine learning model (in accordance with one or more implementations herein) with a selectable option to trigger or initiate a digital action(s) corresponding to the auto suggestion(s). Upon detecting a user interaction with the selectable option, the AI electronic communication system 106 can trigger or initiate a digital action corresponding to the selected auto suggestion. In some embodiments, the AI electronic communication system 106 can display a digital action(s) triggered by the electronic communication evaluation machine learning model in relation to one or more electronic communication interactions from one or more auto suggestions generated by the electronic communication evaluation machine learning model.

In some instances, the AI electronic communication system 106 can utilize the electronic communication evaluation machine learning model to generate a report for an electronic communication interaction and/or multiple electronic communication interactions. For example, the AI electronic communication system 106 can generate a report that includes one or more communication analysis objects, digital actions, and/or auto suggestions generated by the electronic communication evaluation machine learning model for a particular electronic communication interaction. In some instances, the AI electronic communication system 106 can generate a link to navigate to the report (or display as shown in FIG. 5) and display the link in an electronic notification (e.g., via a push notification, message, email) to an administrator device. In some instances, the AI electronic communication system 106 can generate a report that includes one or more communication analysis objects, digital actions, and/or auto suggestions aggregated from the electronic communication evaluation machine learning model evaluating multiple particular electronic communication interactions on the inter-network facilitation system.

In one or more instances, the AI electronic communication system 106 can utilize the electronic communication evaluation machine learning model to summarize an electronic communication interaction between a communication agent machine learning model and a user. For instance, the AI electronic communication system 106 can utilize the electronic communication evaluation machine learning model to summarize relevant portions of the communication interaction based on the evaluation prompts (in accordance with one or more implementations herein).

Additionally, the AI electronic communication system 106 can utilize the electronic communication evaluation machine learning model to categorize electronic communication interactions between a communication agent machine learning model and various users. For instance, the AI electronic communication system 106 can utilize the electronic communication evaluation machine learning model to categorize electronic communication interactions based on a topic of discussion (e.g., a technical issue or concern of the user and/or an identified flag). For instance, the AI electronic communication system 106 can utilize the evaluation machine learning model to identify electronic communication interactions that involve offensive language to categorize those communication interactions under an offensive language flag. As another example, the AI electronic communication system 106 can utilize the evaluation machine learning model to identify electronic communication interactions that involve a discussion of a particular technical issue within an application to categorize these communication interactions under the particular technical issue.

As mentioned above, the AI electronic communication system 106 (via the electronic communication evaluation machine learning model) can trigger a digital action to transmit an electronic notification in response to identifying a circumstance within an electronic communication interaction. For instance, FIG. 6 illustrates the AI electronic communication system 106 utilizing an electronic notification from evaluation detections of the electronic communication evaluation machine learning model in an electronic communication interaction.

As shown in FIG. 6, the AI electronic communication system 106 identifies a communication analysis object(s) 602 and a digital action(s) 604 corresponding to one or more electronic communication interactions (in accordance with one or more implementations herein). As further shown in FIG. 6, the AI electronic communication system 106 utilizes the communication analysis object(s) 602 and/or the digital action(s) 604 to generate and transmit an electronic notification. For instance, as shown in FIG. 6, the AI electronic communication system 106 provides, for display within a graphical user interface 608 (e.g., a chat interface) within an administrator device 606, an electronic notification 612 from an electronic communication evaluation machine learning model 610. Indeed, as shown in FIG. 6, the AI electronic communication system 106 utilizes the electronic notification 612 to notify the administrator of the administrator device 606 that an AI communication bot has been flagged by the electronic communication evaluation machine learning model 610 to have utilized insulting language within an electronic communication interaction.

Furthermore, as shown in FIG. 6, the AI electronic communication system 106 can utilize the electronic notification to provide a variety of selectable options. For example, the AI electronic communication system 106 can utilize the electronic notification to display a selectable option to open a user interface (e.g., a dashboard) that displays communication analysis objects and/or digital actions for a particular or multiple electronic communication interactions (in accordance with one or more implementations herein). Furthermore, the AI electronic communication system 106 can utilize the electronic notification to tag one or more users (e.g., administrators) to direct the electronic notification 612 to relevant users.

In one or more instances, the AI electronic communication system 106 enables messaging interactions via a text box 614 within the graphical user interface 608. Indeed, the AI electronic communication system 106 can utilize input text received within the text box 614 from interactions with the administrator device 606 to configure and/or instruct the electronic communication evaluation machine learning model 610 (in accordance with one or more implementations herein). For example, the AI electronic communication system 106 can enable the administrator (operating the administrator device 606) to input a text prompt as an additional evaluation prompt for the electronic communication evaluation machine learning model 610. Indeed, the AI electronic communication system 106 can utilize input text received within the text box 614 to add, modify, and/or remove a variety of evaluation prompts corresponding to the electronic communication evaluation machine learning model 610. In some cases, the AI electronic communication system 106 can utilize input text received within the text box 614 to confirm or trigger a variety of digital actions and/or auto suggestions generated by the electronic communication evaluation machine learning model 610.

Although one or more embodiments illustrate the AI electronic communication system 106 utilizing electronic notifications in a messaging interface, the AI electronic communication system 106 can enable electronic notifications in various graphical user interfaces, such as, but not limited to, push notifications in a computing device operating system, email notifications in an email user interface, and/or stacked and/or list of notifications in a dashboard corresponding to the electronic communication evaluation machine learning model 610 and/or one or more electronic communication interactions.

As mentioned above, the AI electronic communication system 106 can configure an electronic communication evaluation machine learning model. For example, FIG. 7 illustrates the AI electronic communication system 106 enabling the configuration of an electronic communication evaluation machine learning model through a graphical user interface. Indeed, as shown in FIG. 7, the AI electronic communication system 106 can modify evaluation prompts utilized by the electronic communication evaluation machine learning model to cause the electronic communication evaluation machine learning model to evaluate electronic communication interactions (according to the modified evaluation prompts).

As shown in FIG. 7, the AI electronic communication system 106 provides, for display within a graphical user interface 704 of an administrator device 702, evaluation prompts 706 that are associated with an electronic communication evaluation machine learning model. Indeed, the AI electronic communication system 106 can display the evaluation prompts 706 stored as instructions for the electronic communication evaluation machine learning model to evaluate one or more electronic communication interactions.

Furthermore, as shown in FIG. 7, the AI electronic communication system 106 can display a selectable option 708 to edit an existing evaluation prompt associated with an electronic communication evaluation machine learning model. In particular, upon detecting a user interaction with the selectable option 708, the AI electronic communication system 106 can enable modification of an evaluation prompt from the evaluation prompts 706. In particular, the AI electronic communication system 106 can enable the modification of language associated with the evaluation prompt.

In addition, as shown in FIG. 7, the AI electronic communication system 106 can display a selectable option 710 to delete an existing evaluation prompt associated with an electronic communication evaluation machine learning model. For example, upon detecting a user interaction with the selectable option 710, the AI electronic communication system 106 can remove an evaluation prompt from the evaluation prompts 706. In particular, the AI electronic communication system 106 can disassociate an evaluation prompt from the electronic communication evaluation machine learning model.

Additionally, as shown in FIG. 7, the AI electronic communication system 106 can display a selectable option 712 to enable additional options for the existing evaluation prompt associated with an electronic communication evaluation machine learning model. In particular, the AI electronic communication system 106 can enable options to view the evaluation prompts, view data corresponding to the evaluation prompts (e.g., metrics, statistics), and/or to copy (or assign) the evaluation prompts to one or more additional electronic communication evaluation machine learning model.

Furthermore, as shown in FIG. 7, the AI electronic communication system 106 can display a text box 714 within the graphical user interface 704. Indeed, the AI electronic communication system 106 can utilize input text received within the text box 714 from interactions with the administrator device 702 to configure the electronic communication evaluation machine learning model (in accordance with one or more implementations herein). For example, the AI electronic communication system 106 can enable the administrator (operating the administrator device 702) to input a text prompt as an additional evaluation prompt for the electronic communication evaluation machine learning model. Indeed, the AI electronic communication system 106 can utilize input text received within the text box 714 to add a variety of evaluation prompts for the electronic communication evaluation machine learning model.

For example, the AI electronic communication system 106 can configure a variety of evaluation prompts 716 for an electronic communication evaluation machine learning model 720 to add various check tasks (e.g., tasks for the electronic communication evaluation machine learning model). For example, a check task can include a communication check task, a behavior check task, and/or a suggestion check task.

As shown in FIG. 7, the AI electronic communication system 106 can receive one or more communication check prompts 718a. For instance, the AI electronic communication system 106 can utilize communication check prompts that enable (or instruct) the electronic communication evaluation machine learning model 720 to identify one or more terms or language utilized in an electronic communication interaction (by the AI communication bot). For example, the AI electronic communication system 106 can utilize communication check prompts to prohibit one or more terms for the AI communications bot (e.g., offensive terms, regulation compliance related terms, insulting terms).

As also shown in FIG. 7, the AI electronic communication system 106 can receive one or more behavior check prompts 718b. For instance, the AI electronic communication system 106 can utilize behavior check prompts that enable (or instruct) the electronic communication evaluation machine learning model 720 to detect or check for one or more behavioral traits performed by the AI communication bot. As an example, the AI electronic communication system 106 can utilize behavior check prompts to check for behavior traits, such as, but not limited to, offensive behavior by the AI communication bot, aggressive behavior by the AI communication bot, unprofessional behavior by the AI communication bot.

Moreover, as shown in FIG. 7, the AI electronic communication system 106 can receive one or more suggestion check prompts 718n. In one or more instances, the AI electronic communication system 106 can utilize suggestion check prompts that enable (or instruct) the electronic communication evaluation machine learning model 720 to provide (or determine) particular suggestions for the AI communication bot and/or based on the electronic communication interactions with the AI communication bot. As an example, the AI electronic communication system 106 can utilize suggestion check prompts to instruct the electronic communication evaluation machine learning model 720 to provide suggestions for technical issues experienced by users through electronic communication interactions, suggestions for technical issues experienced by the AI communication bot, digital corrections for the AI communication bot and/or configurations for the AI communication bot.

As an example, the AI electronic communication system 106 can utilize a variety of prompts for an electronic communication evaluation machine learning model. To illustrate, the AI electronic communication system 106 can utilize prompts to instruct the electronic communication evaluation machine learning model to act as a quality analyst tasked to analyze communications of an AI communication bot with users (to evaluate the AI communication bot's performance and user experience). For instance, the AI electronic communication system 106 can further utilize prompts to instruct the electronic communication evaluation machine learning model to read and/or analyze an electronic transcript (as described above) objectively, to answer questions raised in the evaluation prompts, flag problems and/or issues in the communication interaction, and/or to summarize portions of the communication interaction to answer questions and/or flag concerns. Furthermore, the AI electronic communication system 106 can utilize the evaluation prompts to instruct the electronic communication evaluation machine learning model to generate responses and/or evaluations in a particular format (e.g., JSON format, lists, XML structures). In addition, the AI electronic communication system 106 can utilize the evaluation prompts to instruct the electronic communication evaluation machine learning model to identify particular behavior traits and/or actions by defining the behavior traits and/or actions in a prompt for the electronic communication evaluation machine learning model.

In some instances, the AI electronic communication system 106 can utilize evaluation prompts to enable the electronic communication evaluation machine learning model to modify evaluations and/or configurations of the AI communication bot according to changes in social circumstances and/or company policies. For instance, the AI electronic communication system 106 can enable the electronic communication evaluation machine learning model to automatically identify offensive terminology to detect such terminology from communications of the AI communication bot (e.g., to configure the AI communication bot to avoid such terminology). In some cases, the AI electronic communication system 106 can enable the electronic communication evaluation machine learning model to automatically identify discontinued product offerings and/or services and detect such product offerings and/or services from communications of the AI communication bot (e.g., to configure the AI communication bot to avoid such product offerings and/or services)

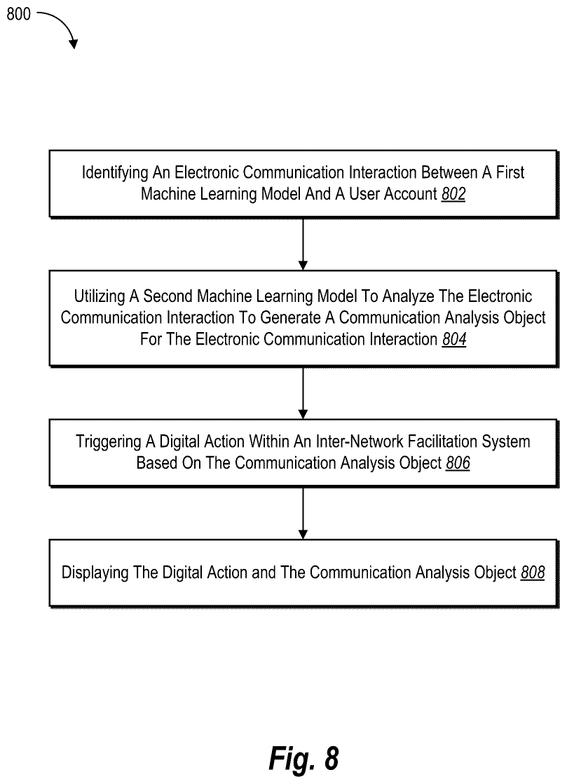

Turning now to FIG. 8, this figure shows a flowchart of a series of acts 800 for utilizing machine learning to evaluate an electronic communication interaction between an artificial intelligence communication (chat) bot and a user of a user account in accordance with one or more implementations. While FIG. 8 illustrates acts according to one embodiment, alternative embodiments may omit, add to, reorder, and/or modify any of the acts shown in FIG. 8. The acts of FIG. 8 can be performed as part of a method. Alternatively, a non-transitory computer readable storage medium can comprise instructions that, when executed by the one or more processors, cause a computing device to perform the acts depicted in FIG. 8. In still further embodiments, a system can perform the acts of FIG. 8.

As shown in FIG. 8, the series of acts 800 include an act 802 of identifying an electronic communication interaction between a first machine learning model and a user account, an act 804 of utilizing a second machine learning model to analyze the electronic communication interaction to generate a communication analysis object for the electronic communication interaction, an act 806 of triggering a digital action within an inter-network facilitation system based on the communication analysis object, and an act 808 of displaying the digital action and the communication analysis object.

In some instances, the series of acts 800 include generating an electronic transcript from an electronic communication interaction between a first machine learning model and a user corresponding to a user account, utilizing a second machine learning model to analyze the electronic transcript to generate a communication analysis object for the electronic communication interaction, triggering a digital action within an inter-network facilitation system based on the communication analysis object, and providing, for display within a graphical user interface of a client device, a set of digital actions and a set of communication analysis objects updated with the digital action and the communication analysis object.

In some implementations, the series of acts 800 include comprising utilizing the second machine learning model to analyze the electronic transcript from a set of evaluation prompts corresponding to the second machine learning model. Additionally, the series of acts 800 can include utilizing a communication check prompt from the set of evaluation prompts to cause the second machine learning model to analyze the electronic transcript for prohibited terms. Moreover, the series of acts 800 can include utilizing a behavior check prompt from the set of evaluation prompts to cause the second machine learning model to analyze a communication behavior of the first machine learning model from the electronic transcript.

Furthermore, the series of acts 800 can include providing, for display within the graphical user interface of the client device, the communication analysis object indicating a response generated by the second machine learning model for the electronic transcript based on an evaluation prompt for the second machine learning model.

Additionally, the series of acts 800 can include providing, for display within the graphical user interface of the client device, a selectable interface element to configure the second machine learning model and, in response to detecting a user interaction with the selectable interface element, enabling an addition of an additional evaluation prompt for the second machine learning model. Moreover, the series of acts 800 can include utilizing the additional evaluation prompt to cause the second machine learning model to analyze the electronic transcript for a check task corresponding to the additional evaluation prompt.

In addition, the series of acts 800 can include triggering the digital action by determining, utilizing the second machine learning model, the first machine learning model generated a prohibited term within the electronic transcript and, in response to determining the first machine learning model generated the prohibited term, transmitting a digital notification to the client device to flag an instance of the first machine learning model generating the prohibited term.

Moreover, the series of acts 800 can include utilizing a suggestion check prompt to cause the second machine learning model to analyze the electronic transcript for automated suggestions for the inter-network facilitation system. Furthermore, the series of acts 800 can include providing, for display within the graphical user interface of the client device, the communication analysis object indicating an automated suggestion for the inter-network facilitation system generated by the second machine learning model for the electronic transcript based on the suggestion check prompt, wherein the automated suggestion comprises a suggested action to perform on the inter-network facilitation system to resolve a technical issue corresponding to the user account from the electronic communication interaction.

Furthermore, the series of acts 800 can include utilizing a suggestion check prompt to cause the second machine learning model to analyze the electronic transcript for automated suggestions for the first machine learning model. Moreover, the series of acts 800 can include providing, for display within the graphical user interface of the client device, a selectable option to modify parameters of the first machine learning model utilizing an automated suggestion generated by the second machine learning model for the electronic transcript based on the suggestion check prompt.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium and executable by one or more computing devices (e.g., any of the media content access devices described herein). In general, a processor (e.g., a microprocessor) receives instructions, from a non-transitory computer-readable medium, (e.g., a memory), and executes those instructions, thereby performing one or more processes, including one or more of the processes described herein.

Computer-readable media can be any available media that can be accessed by a general purpose or special purpose computer system, including by one or more servers. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

Further, upon reaching various computer system components, program code means in the form of computer-executable instructions or data structures can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, virtual reality devices, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

A cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

FIG. 9 illustrates, in block diagram form, an exemplary computing device 900 that may be configured to perform one or more of the processes described above. One will appreciate that the AI electronic communication system 106 (or the inter-network facilitation system 104) can comprise implementations of a computing device, including, but not limited to, the devices or systems illustrated in the previous figures. As shown by FIG. 9, the computing device can comprise a processor 902, memory 904, a storage device 906, an I/O interface 908, and a communication interface 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 906 and decode and execute them.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 904 may be internal or distributed memory.

The computing device 900 includes a storage device 906 includes storage for storing data or instructions. As an example, and not by way of limitation, storage device 906 can comprise a non-transitory storage medium described above. The storage device 906 may include a hard disk drive (“HDD”), flash memory, a Universal Serial Bus (“USB”) drive or a combination of these or other storage devices.

The computing device 900 also includes one or more input or output (“I/O”) interface 908, which are provided to allow a user (e.g., requester or provider) to provide input to (such as user strokes), receive output from, and otherwise transfer data to and from the computing device 900. These I/O interface 908 may include a mouse, keypad or a keyboard, a touch screen, camera, optical scanner, network interface, modem, other known I/O devices or a combination of such I/O interface 908. The touch screen may be activated with a stylus or a finger.

The I/O interface 908 may include one or more devices for presenting output to a user, including, but not limited to, a graphics engine, a display (e.g., a display screen), one or more output providers (e.g., display providers), one or more audio speakers, and one or more audio providers. In certain embodiments, the I/O interface 908 is configured to provide graphical data to a display for presentation to a user. The graphical data may be representative of one or more graphical user interfaces and/or any other graphical content as may serve a particular implementation.

The computing device 900 can further include a communication interface 910. The communication interface 910 can include hardware, software, or both. The communication interface 910 can provide one or more interfaces for communication (such as, for example, packet-based communication) between the computing device and one or more other computing devices 900 or one or more networks. As an example, and not by way of limitation, communication interface 910 may include a network interface controller (“NIC”) or network adapter for communicating with an Ethernet or other wire-based network or a wireless NIC (“WNIC”) or wireless adapter for communicating with a wireless network, such as a WI-FI. The computing device 900 can further include a bus 912. The bus 912 can comprise hardware, software, or both that couples components of computing device 900 to each other.

FIG. 10 illustrates an example network environment 1000 of the inter-network facilitation system 104. The network environment 1000 includes a client device 1006 (e.g., client device(s) 114 and administrator device 110), an inter-network facilitation system 104, and a third-party system 1008 connected to each other by a network 1004. Although FIG. 10 illustrates a particular arrangement of the client device 1006, the inter-network facilitation system 104, the third-party system 1008, and the network 1004, this disclosure contemplates any suitable arrangement of client device 1006, the inter-network facilitation system 104, the third-party system 1008, and the network 1004. As an example, and not by way of limitation, two or more of client device 1006, the inter-network facilitation system 104, and the third-party system 1008 communicate directly, bypassing network 1004. As another example, two or more of client device 1006, the inter-network facilitation system 104, and the third-party system 1008 may be physically or logically co-located with each other in whole or in part.

Moreover, although FIG. 10 illustrates a particular number of client devices 1006, inter-network facilitation system 104, third-party systems 1008, and networks 1004, this disclosure contemplates any suitable number of client devices 1006, FIG. 10, third-party systems 1008, and networks 1004. As an example, and not by way of limitation, network environment 1000 may include multiple client devices 1006, inter-network facilitation system 104, third-party systems 1008, and/or networks 1004.

This disclosure contemplates any suitable network 1004. As an example, and not by way of limitation, one or more portions of network 1004 may include an ad hoc network, an intranet, an extranet, a virtual private network (“VPN”), a local area network (“LAN”), a wireless LAN (“WLAN”), a wide area network (“WAN”), a wireless WAN (“WWAN”), a metropolitan area network (“MAN”), a portion of the Internet, a portion of the Public Switched Telephone Network (“PSTN”), a cellular telephone network, or a combination of two or more of these. Network 1004 may include one or more networks 1004.

Links may connect client device 1006, inter-network facilitation system 104 (e.g., which hosts the AI electronic communication system 106), and third-party system 1008 to network 1004 or to each other. This disclosure contemplates any suitable links. In particular embodiments, one or more links include one or more wireline (such as for example Digital Subscriber Line (“DSL”) or Data Over Cable Service Interface Specification (“DOCSIS”), wireless (such as for example Wi-Fi or Worldwide Interoperability for Microwave Access (“WiMAX”), or optical (such as for example Synchronous Optical Network (“SONET”) or Synchronous Digital Hierarchy (“SDH”) links. In particular embodiments, one or more links each include an ad hoc network, an intranet, an extranet, a VPN, a LAN, a WLAN, a WAN, a WWAN, a MAN, a portion of the Internet, a portion of the PSTN, a cellular technology-based network, a satellite communications technology-based network, another link, or a combination of two or more such links. Links need not necessarily be the same throughout network environment 1000. One or more first links may differ in one or more respects from one or more second links.

In particular embodiments, the client device 1006 may be an electronic device including hardware, software, or embedded logic components or a combination of two or more such components and capable of carrying out the appropriate functionalities implemented or supported by client device 1006. As an example, and not by way of limitation, a client device 1006 may include any of the computing devices discussed above in relation to FIG. 9. A client device 1006 may enable a network user at the client device 1006 to access network 1004. A client device 1006 may enable its user to communicate with other users at other client devices 1006.

In particular embodiments, the client device 1006 may include a requester application or a web browser, such as MICROSOFT INTERNET EXPLORER, GOOGLE CHROME, or MOZILLA FIREFOX, and may have one or more add-ons, plug-ins, or other extensions, such as TOOLBAR or YAHOO TOOLBAR. A user at the client device 1006 may enter a Uniform Resource Locator (“URL”) or other address directing the web browser to a particular server (such as server), and the web browser may generate a Hyper Text Transfer Protocol (“HTTP”) request and communicate the HTTP request to server. The server may accept the HTTP request and communicate to the client device 1006 one or more Hyper Text Markup Language (“HTML”) files responsive to the HTTP request. The client device 1006 may render a webpage based on the HTML files from the server for presentation to the user. This disclosure contemplates any suitable webpage files. As an example, and not by way of limitation, webpages may render from HTML files, Extensible Hyper Text Markup Language (“XHTML”) files, or Extensible Markup Language (“XML”) files, according to particular needs. Such pages may also execute scripts such as, for example and without limitation, those written in JAVASCRIPT, JAVA, MICROSOFT SILVERLIGHT, combinations of markup language and scripts such as AJAX (Asynchronous JAVASCRIPT and XML), and the like. Herein, reference to a webpage encompasses one or more corresponding webpage files (which a browser may use to render the webpage) and vice versa, where appropriate.

In particular embodiments, inter-network facilitation system 104 may be a network-addressable computing system that can interface between two or more computing networks or servers associated with different entities such as financial institutions (e.g., banks, credit processing systems, ATM systems, or others). In particular, the inter-network facilitation system 104 can send and receive network communications (e.g., via the network 1004) to link the third-party-system 1008. For example, the inter-network facilitation system 104 may receive authentication credentials from a user to link a third-party system 1008 such as an online bank account, credit account, debit account, or other financial account to a user account within the inter-network facilitation system 104. The inter-network facilitation system 104 can subsequently communicate with the third-party system 1008 to detect or identify balances, transactions, withdrawal, transfers, deposits, credits, debits, or other transaction types associated with the third-party system 1008. The inter-network facilitation system 104 can further provide the aforementioned or other financial information associated with the third-party system 1008 for display via the client device 1006. In some cases, the inter-network facilitation system 104 links more than one third-party system 1008, receiving account information for accounts associated with each respective third-party system 1008 and performing operations or transactions between the different systems via authorized network connections.

In particular embodiments, the inter-network facilitation system 104 may interface between an online banking system and a credit processing system via the network 1004. For example, the inter-network facilitation system 104 can provide access to a bank account of a third-party system 1008 and linked to a user account within the inter-network facilitation system 104. Indeed, the inter-network facilitation system 104 can facilitate access to, and transactions to and from, the bank account of the third-party system 1008 via a client application of the inter-network facilitation system 104 on the client device 1006. The inter-network facilitation system 104 can also communicate with a credit processing system, an ATM system, and/or other financial systems (e.g., via the network 1004) to authorize and process credit charges to a credit account, perform ATM transactions, perform transfers (or other transactions) across accounts of different third-party systems 1008, and to present corresponding information via the client device 1006.

In particular embodiments, the inter-network facilitation system 104 includes a model for approving or denying transactions. For example, the inter-network facilitation system 104 includes a transaction approval machine learning model that is trained based on training data such as user account information (e.g., name, age, location, and/or income), account information (e.g., current balance, average balance, maximum balance, and/or minimum balance), credit usage, and/or other transaction history. Based on one or more of these data (from the inter-network facilitation system 104 and/or one or more third-party systems 1008), the inter-network facilitation system 104 can utilize the transaction approval machine learning model to generate a prediction (e.g., a percentage likelihood) of approval or denial of a transaction (e.g., a withdrawal, a transfer, or a purchase) across one or more networked systems.

The inter-network facilitation system 104 may be accessed by the other components of network environment 1000 either directly or via network 1004. In particular embodiments, the inter-network facilitation system 104 may include one or more servers. Each server may be a unitary server or a distributed server spanning multiple computers or multiple datacenters. Servers may be of various types, such as, for example and without limitation, web server, news server, mail server, message server, advertising server, file server, application server, exchange server, database server, proxy server, another server suitable for performing functions or processes described herein, or any combination thereof. In particular embodiments, each server may include hardware, software, or embedded logic components or a combination of two or more such components for carrying out the appropriate functionalities implemented or supported by the server. In particular embodiments, the inter-network facilitation system 104 may include one or more data stores. Data stores may be used to store various types of information. In particular embodiments, the information stored in data stores may be organized according to specific data structures. In particular embodiments, each data store may be a relational, columnar, correlation, or other suitable database. Although this disclosure describes or illustrates particular types of databases, this disclosure contemplates any suitable types of databases. Particular embodiments may provide interfaces that enable a client device 1006, or an inter-network facilitation system 104 to manage, retrieve, modify, add, or delete, the information stored in a data store.

In particular embodiments, the inter-network facilitation system 104 may provide users with the ability to take actions on various types of items or objects, supported by the inter-network facilitation system 104. As an example, and not by way of limitation, the items and objects may include financial institution networks for banking, credit processing, or other transactions, to which users of the inter-network facilitation system 104 may belong, computer-based applications that a user may use, transactions, interactions that a user may perform, or other suitable items or objects. A user may interact with anything that is capable of being represented in the inter-network facilitation system 104 or by an external system of a third-party system, which is separate from inter-network facilitation system 104 and coupled to the inter-network facilitation system 104 via a network 1004.

In particular embodiments, the inter-network facilitation system 104 may be capable of linking a variety of entities. As an example, and not by way of limitation, the inter-network facilitation system 104 may enable users to interact with each other or other entities, or to allow users to interact with these entities through an application programming interfaces (“API”) or other communication channels.

In particular embodiments, the inter-network facilitation system 104 may include a variety of servers, sub-systems, programs, modules, logs, and data stores. In particular embodiments, the inter-network facilitation system 104 may include one or more of the following: a web server, action logger, API-request server, transaction engine, cross-institution network interface manager, notification controller, action log, third-party-content-object-exposure log, inference module, authorization/privacy server, search module, user-interface module, user-profile (e.g., provider profile or requester profile) store, connection store, third-party content store, or location store. The inter-network facilitation system 104 may also include suitable components such as network interfaces, security mechanisms, load balancers, failover servers, management-and-network-operations consoles, other suitable components, or any suitable combination thereof. In particular embodiments, the inter-network facilitation system 104 may include one or more user-profile stores for storing user profiles for transportation providers and/or transportation requesters. A user profile may include, for example, biographic information, demographic information, financial information, behavioral information, social information, or other types of descriptive information, such as interests, affinities, or location.

The web server may include a mail server or other messaging functionality for receiving and routing messages between the inter-network facilitation system 104 and one or more client devices 1006. An action logger may be used to receive communications from a web server about a user's actions on or off the inter-network facilitation system 104. In conjunction with the action log, a third-party-content-object log may be maintained of user exposures to third-party-content objects. A notification controller may provide information regarding content objects to a client device 1006. Information may be pushed to a client device 1006 as notifications, or information may be pulled from client device 1006 responsive to a request received from client device 1006. Authorization servers may be used to enforce one or more privacy settings of the users of the inter-network facilitation system 104. A privacy setting of a user determines how particular information associated with a user can be shared. The authorization server may allow users to opt in to or opt out of having their actions logged by the inter-network facilitation system 104 or shared with other systems, such as, for example, by setting appropriate privacy settings. Third-party-content-object stores may be used to store content objects received from third parties. Location stores may be used for storing location information received from client devices 1006 associated with users.

In addition, the third-party system 1008 can include one or more computing devices, servers, or sub-networks associated with internet banks, central banks, commercial banks, retail banks, credit processors, credit issuers, ATM systems, credit unions, loan associates, brokerage firms, linked to the inter-network facilitation system 104 via the network 1004. A third-party system 1008 can communicate with the inter-network facilitation system 104 to provide financial information pertaining to balances, transactions, and other information, whereupon the inter-network facilitation system 104 can provide corresponding information for display via the client device 1006. In particular embodiments, a third-party system 1008 communicates with the inter-network facilitation system 104 to update account balances, transaction histories, credit usage, and other internal information of the inter-network facilitation system 104 and/or the third-party system 1008 based on user interaction with the inter-network facilitation system 104 (e.g., via the client device 1006). Indeed, the inter-network facilitation system 104 can synchronize information across one or more third-party systems 1008 to reflect accurate account information (e.g., balances, transactions, etc.) across one or more networked systems, including instances where a transaction (e.g., a transfer) from one third-party system 1008 affects another third-party system 1008.

In the foregoing specification, the invention has been described with reference to specific exemplary embodiments thereof. Various embodiments and aspects of the invention(s) are described with reference to details discussed herein, and the accompanying drawings illustrate the various embodiments. The description above and drawings are illustrative of the invention and are not to be construed as limiting the invention. Numerous specific details are described to provide a thorough understanding of various embodiments of the present invention.

The present invention may be embodied in other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

What is claimed is:

1. A computer-implemented method comprising:
generating an electronic transcript from an electronic communication interaction between a first machine learning model and a user corresponding to a user account;
utilizing a second machine learning model to analyze the electronic transcript to generate a communication analysis object for the electronic communication interaction;
triggering a digital action within an inter-network facilitation system based on the communication analysis object; and
providing, for display within a graphical user interface of a client device, a set of digital actions and a set of communication analysis objects updated with the digital action and the communication analysis object.

2. The computer-implemented method of claim 1, further comprising utilizing the second machine learning model to analyze the electronic transcript from a set of evaluation prompts corresponding to the second machine learning model.

3. The computer-implemented method of claim 2, further comprising utilizing a communication check prompt from the set of evaluation prompts to cause the second machine learning model to analyze the electronic transcript for prohibited terms.

4. The computer-implemented method of claim 2, further comprising utilizing a behavior check prompt from the set of evaluation prompts to cause the second machine learning model to analyze a communication behavior of the first machine learning model from the electronic transcript.

5. The computer-implemented method of claim 1, further comprising providing, for display within the graphical user interface of the client device, the communication analysis object indicating a response generated by the second machine learning model for the electronic transcript based on an evaluation prompt for the second machine learning model.

6. The computer-implemented method of claim 1, further comprising:
providing, for display within the graphical user interface of the client device, a selectable interface element to configure the second machine learning model; and
in response to detecting a user interaction with the selectable interface element, enabling an addition of an additional evaluation prompt for the second machine learning model.

7. The computer-implemented method of claim 6, further comprising utilizing the additional evaluation prompt to cause the second machine learning model to analyze the electronic transcript for a check task corresponding to the additional evaluation prompt.

8. The computer-implemented method of claim 1, further comprising triggering the digital action by:
determining, utilizing the second machine learning model, the first machine learning model generated a prohibited term within the electronic transcript; and
in response to determining the first machine learning model generated the prohibited term, transmitting a digital notification to the client device to flag an instance of the first machine learning model generating the prohibited term.

9. The computer-implemented method of claim 1, further comprising:
utilizing a suggestion check prompt to cause the second machine learning model to analyze the electronic transcript for automated suggestions for the inter-network facilitation system; and
providing, for display within the graphical user interface of the client device, the communication analysis object indicating an automated suggestion for the inter-network facilitation system generated by the second machine learning model for the electronic transcript based on the suggestion check prompt, wherein the automated suggestion comprises a suggested action to perform on the inter-network facilitation system to resolve a technical issue corresponding to the user account from the electronic communication interaction.

10. The computer-implemented method of claim 1, further comprising:
utilizing a suggestion check prompt to cause the second machine learning model to analyze the electronic transcript for automated suggestions for the first machine learning model; and
providing, for display within the graphical user interface of the client device, a selectable option to modify parameters of the first machine learning model utilizing an automated suggestion generated by the second machine learning model for the electronic transcript based on the suggestion check prompt.

11. A non-transitory computer-readable medium storing instructions that, when executed by at least one processor, cause a computing device to:
generate an electronic transcript from an electronic communication interaction between a first machine learning model and a user corresponding to a user account;
utilize a second machine learning model to analyze the electronic transcript to generate a communication analysis object for the electronic communication interaction;
trigger a digital action within an inter-network facilitation system based on the communication analysis object; and
provide, for display within a graphical user interface of a client device, a set of digital actions and a set of communication analysis objects updated with the digital action and the communication analysis object.

12. The non-transitory computer-readable medium of claim 11, further comprising instructions that, when executed by the at least one processor, cause the computing device to utilize the second machine learning model to analyze the electronic transcript from a set of evaluation prompts corresponding to the second machine learning model.

13. The non-transitory computer-readable medium of claim 12, further comprising instructions that, when executed by the at least one processor, cause the computing device to utilize a communication check prompt from the set of evaluation prompts to cause the second machine learning model to analyze the electronic transcript for prohibited terms.

14. The non-transitory computer-readable medium of claim 12, further comprising instructions that, when executed by the at least one processor, cause the computing device to utilize a behavior check prompt from the set of evaluation prompts to cause the second machine learning model to analyze a communication behavior of the first machine learning model from the electronic transcript.

15. The non-transitory computer-readable medium of claim 11, further comprising instructions that, when executed by the at least one processor, cause the computing device to:
provide, for display within the graphical user interface of the client device, a selectable interface element to configure the second machine learning model; and
in response to detecting a user interaction with the selectable interface element, enable an addition of an additional evaluation prompt for the second machine learning model.

16. A system comprising:
at least one processor; and
at least one non-transitory computer-readable storage medium storing instructions that, when executed by the at least one processor, cause the system to:
generate an electronic transcript from an electronic communication interaction between a first machine learning model and a user corresponding to a user account;
utilize a second machine learning model to analyze the electronic transcript to generate a communication analysis object for the electronic communication interaction;
trigger a digital action within an inter-network facilitation system based on the communication analysis object; and
provide, for display within a graphical user interface of a client device, a set of digital actions and a set of communication analysis objects updated with the digital action and the communication analysis object.

17. The system of claim 16, further comprising instructions that, when executed by the at least one processor, cause the system to utilize the second machine learning model to analyze the electronic transcript from a set of evaluation prompts corresponding to the second machine learning model.

18. The system of claim 16, further comprising instructions that, when executed by the at least one processor, cause the system to:
provide, for display within the graphical user interface of the client device, a selectable interface element to configure the second machine learning model; and
in response to detecting a user interaction with the selectable interface element, enable an addition of an additional evaluation prompt for the second machine learning model.

19. The system of claim 18, further comprising instructions that, when executed by the at least one processor, cause the system to utilize the additional evaluation prompt to cause the second machine learning model to analyze the electronic transcript for a check task corresponding to the additional evaluation prompt.

20. The system of claim 16, further comprising instructions that, when executed by the at least one processor, cause the system to trigger the digital action by:
determining, utilizing the second machine learning model, the first machine learning model generated a prohibited term within the electronic transcript; and
in response to determining the first machine learning model generated the prohibited term, transmitting a digital notification to the client device to flag an instance of the first machine learning model generating the prohibited term.
